(19) United States
(12) Patent Application Publication
(10) Pub. No.: US 2026/0243307 A1
(43) Pub. Date: Aug. 20, 2026

(54) SEALED BALL BEARING AND BEARING DEVICE

(71) Applicant: NTN CORPORATION, Osaka (JP)

(72) Inventors: Yuuki HASHIZUME, Shizuoka (JP); Shohei FUKAMA, Shizuoka (JP)

(73) Assignee: NTN CORPORATION, Osaka (JP)

(21) Appl. No.: 19/489,505

(22) PCT Filed: Jun. 5, 2024
(86) PCT No.: PCT/JP2024/020550

§ 371 Date: Dec. 2, 2025

(30) Foreign Application Priority Data
Jun. 8, 2023 (JP) 2023-094651

(51) Int. Cl. F16C 33/66; F16C 19/06; F16C 33/38; F16C 33/44; F16C 33/78

(52) U.S. Cl. CPC F16C 33/6681; F16C 19/06; F16C 33/3831; F16C 33/44; F16C 33/7823; F16C 2208/10; F16C 2240/26; F16C 2240/70; F16C 2380/26

(57) ABSTRACT

Provided is a ball bearing comprising a crown-shaped cage containing an engineering plastic, φx<2Ry<2Rz is satisfied, wherein φx is a diameter of each ball, Ry is a radius of a radially inner peripheral surface of each pocket on a cross section passing through a pocket center and including a center axis of the bearing, and Rz is a radius of a circumferentially inner peripheral surface of each pocket on a cross section taken through the pocket center in a direction orthogonal to a bearing radial straight line passing through the pocket center, and a center of a second inner peripheral surface portion is offset toward a base relative to a center of a first inner peripheral surface portion.

### TECHNICAL FIELD

The present invention relates to a sealed ball bearing and a bearing device.

### BACKGROUND ART

For example, in various vehicles such as automobiles and construction machinery, as well as various other industrial machines, a large number of bearings are used for motor shafts of gearboxes (speed increasers/reducers) comprising drive motors. Bearings used for these devices are generally used under higher-speed conditions compared to bearings used for shaft support in general machinery. In lubricating oils used in these devices, foreign matter, such as gear wear particles, may be present. Thus, by disposing a seal member at an end of the bearing, the entry of foreign matter into the bearing is prevented, thereby inhibiting a decrease in the service life of the bearing, and the amount of lubricating oil entering the bearing is reduced, thereby reducing the stirring resistance.

For example, in the below-identified Patent Document 1, by providing protrusions on a seal lip disposed in a seal member and forming oil passages that communicate between the interior and exterior of the bearing, a fluid lubrication regime between the seal lip and a seal sliding surface is achieved. Consequently, fluid lubrication at the seal portions is achieved, while a decrease in the service life of the bearing due to gear wear particles or the like is inhibited, thereby reducing the seal torque.

In addition, the below-identified Patent Document 2 discloses a technology relating to a crown-shaped cage comprising an annular base and pillars protruding from the base, wherein a radial wall thickness of the crown-shaped cage is gradually reduced from the base toward the distal ends of the pillars, and a radial gap between the outer peripheral surface of the base and the inner peripheral surface of a shoulder of the outer ring is greater than a radial gap between the inner peripheral surface of the base and the outer peripheral surface of a shoulder of the inner ring.

According to Patent Document 2, even if the lubricant is scattered by centrifugal force during high-speed rotation, the lubricant is retained between the outer peripheral surface of the base and the inner peripheral surface of the shoulder of the outer ring, thereby reducing entry of the lubricant onto the raceway surface of the outer ring. Consequently, the stirring resistance can be reduced, thereby enabling a reduction in torque and heat generation, and also reducing deformation of the cage due to centrifugal force during high-speed rotation.

### PRIOR ART DOCUMENT(S)

### Patent Document(s)

Patent Document 1: WO 2016/143786 A1
Patent Document 2: Japanese Unexamined Patent Application Publication No. 2021-195973

### SUMMARY OF THE INVENTION

### Problems to be Solved by the Invention

In Patent Document 1, a decrease in the service life of the bearing can be inhibited. However, in bearings used under high-speed conditions to support the motor shafts of the drive motors, heat generation of the raceway surfaces due to interference with the cage, as well as damage to the cage, may be a concern under severe operating conditions exceeding the assumed limits.

In addition, in Patent Document 2, countermeasures against damage to the cage under high-speed conditions are made. However, although this bearing comprises the seal members disposed at the axial ends of the bearing, the seal members are non-contact seals and therefore cannot prevent entry of foreign matter of a size that affects the service life of the bearing. Thus, if this bearing is used in apparatuses such as gearboxes and speed increasers/reducers, a decrease in the service life of the bearing due foreign matter entering the bearing may be a concern. Further, apparatuses that integrally comprise drive motors, inverters, and gears (such as gearboxes) are recently becoming widely used. Such apparatuses are primarily lubricated with oil, and therefore bearings supporting the motor shafts of the drive motors are also likely to be lubricated with the same oil as that used in the gearboxes or the like. Consequently, there may be a need to more reliably prevent foreign matter from entering the bearing.

It is an object of the present invention to reduce deformation of the cage under high-speed conditions while preventing foreign matter from entering the bearing inner space.

### Means for Solving the Problems

In order to achieve the above object, the present invention provides a sealed ball bearing comprising:
an inner ring and an outer ring between which a bearing inner space is defined;
balls disposed between the inner ring and the outer ring;
a cage having pockets circumferentially retaining the respective balls; and
a seal member closing an axial end opening of the bearing inner space,
wherein the sealed ball bearing is used in an environment of a dmn value of 700,000 or more, the dmn value being defined by:

$$dms = \{ ( D + d ) / 2 \} \times n ,$$

D: Bearing outer diameter (mm),
d: Bearing inner diameter (mm), and
n: Rotational speed (min⁻¹),
wherein the seal member comprises a seal lip that is fixed to one of the inner ring and the outer ring, and that is in sliding contact with a seal sliding surface of the other of the inner ring and the outer ring,
wherein the seal lip includes a plurality of protrusions circumferentially spaced apart from each other such that gaps are defined between respective circumferentially adjacent pairs of the protrusions, and such that, during rotation of the bearing, a lubricating oil is dragged from the gaps to between the protrusions and the seal sliding surface so as to form an oil film therebetween, thereby achieving a fluid lubrication regime between the seal lip and the seal sliding surface,
wherein the cage is a crown-shaped cage containing an engineering plastic, and comprising an annular base and a plurality of pillars protruding unidirectionally from the base,
wherein a dimensional relationship among φx, Ry, and Rz satisfies φx<2Ry<2Rz, wherein φx is a diameter of each of the balls, Ry is a radius of a radially inner peripheral surface of each the pockets on a cross section passing through a pocket center of the pocket and including a center axis of the bearing, and Rz is a radius of a circumferentially inner peripheral surface of each of the pockets on a cross section taken through the pocket center in a direction orthogonal to a bearing radial straight line passing through the pocket center, and
wherein the circumferential inner peripheral surface of each of the pockets has a first inner peripheral surface portion on a side of the base and a second inner peripheral surface portion extending toward distal ends of corresponding ones of the pillars beyond the first inner peripheral surface, and a center of the second inner peripheral surface is offset toward the base relative to a center of the first inner peripheral surface portion (arrangement 1).

In the arrangement 1, an arrangement 2 may be used in which the radius Rz of the circumferentially inner peripheral surface of each of the pockets is set such that a radius Rz₁ of the first inner peripheral surface portion is equal to a radius Rz₂ of the second inner peripheral surface portion.

In addition, in the arrangement 1, an arrangement 3 may be used in which a recess as an oil reservoir, is disposed between the first inner peripheral surface portion and the second inner peripheral surface portion in each of the pockets.

Further, in the arrangement 1, an arrangement 4 may be used in which the seal lip is formed of a single material or a plurality of materials selected from nitrile rubber, acrylic rubber, and fluororubber.

Furthermore, in the arrangement 1, an arrangement 5 may be used in which a lubricant is to be supplied to the bearing inner space in a single direction from a first axial end of the bearing inner space toward a second axial end of the bearing inner space, and the seal member is disposed only in an opening of the bearing inner space at the first axial end.

Furthermore, a plurality of components selected from the arrangements 2 to 5 may be added to the arrangement 1. That is, examples of the components to be added to the arrangement 1 may include the arrangements 2 and 3, the arrangements 2 and 4, the arrangements 2 and 5, the arrangements 2, 3 and 4, the arrangements 2, 3 and 5, the arrangements 2, 4 and 5, and the arrangements 2, 3, 4 and 5.

Furthermore, a bearing device may be provided wherein the sealed ball bearing according to each of these embodiments is used, and wherein a rotary shaft of a drive motor, a speed reducer, or a speed increaser for electric transportation equipment is supported by the sealed ball bearing.

### Effects of the Invention

According to the present invention, by using the seal member capable of maintaining an interface between the seal lip and the seal sliding surface in the fluid lubrication regime, it is possible to reduce seal torque and control an amount of lubricant entering the bearing inner space. As a result, the stirring resistance of the lubricant within the bearing inner space is reduced, thereby enabling application of the bearing in a high-speed range with the dmn value of 700,000 or more. In addition, the entry of foreign matter having a size that adversely affects the service life of the bearing can be also reduced.

In addition, an engineering plastic is used as the material for the crown-shaped cage, the dimensional relationship among the diameter φx of each of the balls of the ball bearing, the radius Ry of the radially inner peripheral surface of each of the pockets of the cage, and the radius Rz of the circumferentially inner peripheral surface of each of the pockets of the cage is optimized, and, of the circumferential inner peripheral surface, the center of the second inner peripheral surface portion, disposed on the side away from the base, is offset toward the base relative to the center of the first inner peripheral surface portion, disposed on the side of the base, thereby reducing deformation of the cage during high-speed operation and preventing jamming of foreign matter between the cage and the seal member.

### BRIEF DESCRIPTION OF THE DRAWINGS

FIG. 1 is a vertical sectional view showing an embodiment of the present invention.

FIG. 2 is an enlarged view of a portion of FIG. 1.

FIG. 3 is a vertical sectional view showing a portion of the cage.

FIG. 4 is a sectional view showing a portion of the cage, taken in a direction orthogonal to the bearing radial direction (i.e., a sectional view taken along line IV-IV of FIG. 3).

FIG. 5 is a schematic view showing the relationship between the cage and the ball.

FIG. 6 is an enlarged view showing a portion of the vicinity of the seal lip.

FIG. 7A is a right-side view of FIG. 6.

FIG. 7B is an enlarged view of a portion of FIG. 7A.

FIG. 8 is a vertical sectional view showing the variation.

### BEST MODE FOR CARRYING OUT THE INVENTION

An embodiment of the present invention will be described below with reference to the attached drawings. This embodiment is directed to a rolling bearing 1 comprising seal members 20 disposed in axial end openings of the bearing inner space.

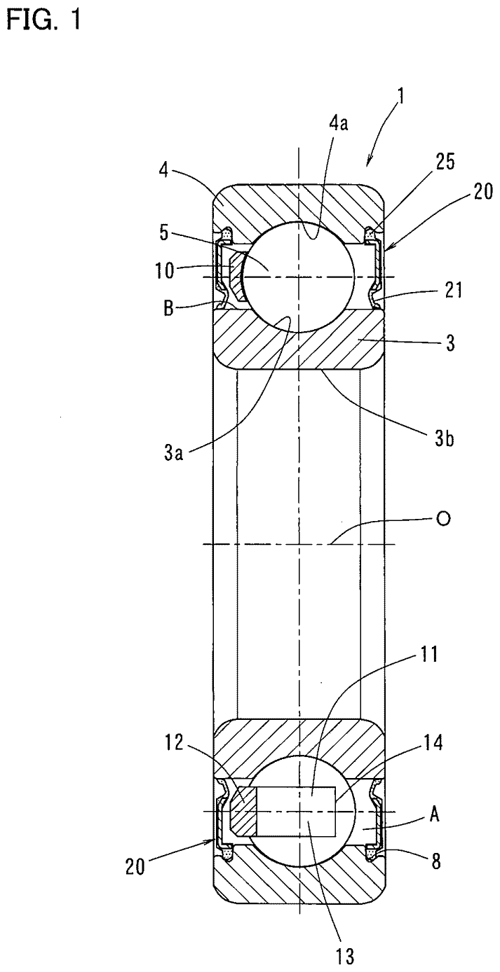

As shown in FIGS. 1 to 3, the rolling bearing 1 comprises an inner ring 3 and an outer ring 4, a plurality of rolling elements 5 arranged between the inner ring 3 and the outer ring 4, and a cage 10 having pockets 11 circumferentially retaining the respective rolling elements 5. Since spheres (steel balls) are used as the rolling elements 5, the rolling elements 5 are hereinafter referred to as the “balls 5”. In addition, this rolling bearing 1 is hereinafter referred to as the “sealed ball bearing 1”, or simply referred to as the “bearing 1”. Further, the direction along the bearing center axis of the bearing 1 is referred to as the “bearing axial direction” (or simply referred to as the “axial direction”), “axial” or “axially”. The direction orthogonal to the axial direction is referred to as the “bearing radial direction” (or simply referred to as the “radial direction”), “radial” or “radially”. The circumferential direction around the bearing center axis is referred to as the “bearing circumferential direction” (or simply referred to as the “circumferential direction”), “circumferential” or “circumferentially”.

The cage 10 is a crown-shaped cage molded from an engineering plastic. The cage 10 comprises an annular base 12, and a plurality of pillars 13 protruding axially from the base 12. Each pair of pillars 13 arranged circumferentially side by side are disposed at a predetermined interval along the circumferential direction. The each pair of pillars 13 define a recessed pocket 11. The radially outer surface of the cage 10 is a curved surface (cylindrical surface) which does not include any steps. The radially outer surface of the cage 10 is in communication with the radially inner surface of the cage 10 through the pockets 11.

The distal end of each pillar 13 forms a retaining claw 14. The retaining claws 14 on both sides of each pocket 11 are curved toward each other. The adjacent pillars 13 between each circumferentially adjacent pair of pockets 11 may be coupled to each other. The balls 5, which are retained in the pockets 11, revolve around the bearing center axis between the raceway surface 3a of the inner ring 3 and the raceway surface 4a of the outer ring 4.

A rotary shaft (not shown) is fixed to the radially inner portion 3b of the inner ring 3, and the inner ring 3 rotates circumferentially in unison with the rotary shaft. The outer ring 4 is attached to a fixing member, such as a housing or a gear (both are not shown), to which a load from the rotary shaft is applied. Accordingly, the bearing 1 supports the rotary shaft so as to be rotatable relative to the fixing member. Examples of the rotary shaft include, e.g., a rotary shaft of a drive motor of electric transportation equipment, such as an electric vehicle, and a rotary shaft of a speed reducer or a speed increaser of the electric transportation equipment. The bearing center axis of the bearing 1 and the rotational center axis of the rotary shaft are coaxial with each other.

When installing the bearing 1, an appropriate lubricant, such as grease, is sealed in the bearing inner space A. In addition, during operation, a lubricant (lubricating oil) is supplied from the outside into the bearing inner space A through the opening of the bearing inner space A at one axial end thereof. The lubricant (lubricating oil) in the bearing inner space A is to flow out of the bearing inner space A through the opening of the bearing inner space A at the other axial end thereof The bearing 1 is basically used under oil lubrication, and the grease sealed for initial lubrication is replaced with lubricating oil supplied from the exterior of the bearing. When the grease is sealed for the initial lubrication, the grease is desirably sealed so as to account for 5 to 20% of the total space volume of the bearing inner space A.

Present in the lubricating oil used for lubricating devices such as drive motors and gearboxes are gear wear dust, clutch wear dust, and other foreign matter corresponding to the device in which the bearing 1 is installed. Such foreign matter is desirably captured at some location without floating in the lubricating oil. In addition, the bearing 1 is lubricated with the same lubricating oil as used in devices such as drive motors or gearboxes. Accordingly, a seal member or members 20 as mentioned above are attached to one or both of the axial end openings of the bearing inner space A. In this embodiment, the seal members 20 are disposed at the respective axial ends of the bearing inner space A.

The seal members 20 are annular members covering the respective axial end openings of the bearing inner space A. The seal members 20 partition the bearing inner space A from the exterior. On the outer side of the bearing with respect to the seal members 20, foreign matter is present in the lubricating oil. Accordingly, the seal members 20 prevent such foreign matter from entering the bearing inner space A from the exterior of the bearing.

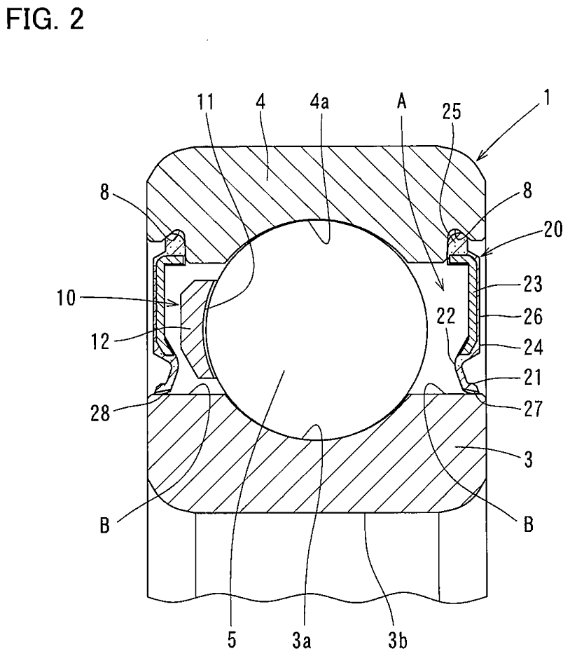

As shown in FIG. 2, each seal member 20 comprises a metal core 23 formed of a metallic material, and an elastic portion 24 integrally fixed to the metal core 23. The metal core 23 is an annular member molded to have an L-shaped cross section around the entire circumference. In this embodiment, the metal core 23 is formed by pressing. The elastic portion 24 is formed of rubber and is bonded by vulcanization to the metal core 23. The vulcanized bonding is achievable, for example, by placing the metal core 23 in a mold and molding a vulcanizable rubber material onto it through vulcanization.

The elastic portion 24 of each seal member 20 comprises a fitting portion 25 disposed on the radially outer side so as to protrude radially outward, a body 26 covering the metal core 23, an extension 22 protruding radially inward from the body 26, and a seal lip 21 protruding radially inward from the distal end of the extension 22 so as to have a tongue shape. Seal grooves 8 are formed in the inner periphery of the outer ring 4 at the respective axial ends thereof so as to extend around the entire circumference. The seal members 20 are fixed to the outer ring 4 by the fitting of the fitting portions 25 in the respective seal grooves 8.

Seal sliding surfaces B which slide circumferentially relative to the respective seal lips 21 of the seal members 20 are formed on the outer periphery of the inner ring 3. The seal sliding surfaces B are cylindrical surfaces extending around the entire circumference.

As shown in FIG. 6, the seal lip 21 of each seal member 20 includes a waist portion 22 formed into a circular annular shape, and extending continuously radially with a certain axial width, and a head portion formed as a protruding piece bent from the waist portion 22 outward. An interference fit is set between the head portion of the seal lip 21 and the corresponding seal sliding surface B. When the seal members 20 are attached to predetermined positions shown in FIGS. 1 and 2, the seal lips 21 are pressed against the respective seal sliding surfaces B by the interference fit. This causes rubber-like elastic deformation that bends axially outward, thereby generating a tightening force at each seal lip 21. Attachment errors, production errors, and the like of the seal members 20 are absorbed by variations in the deflection of the seal lips 21.

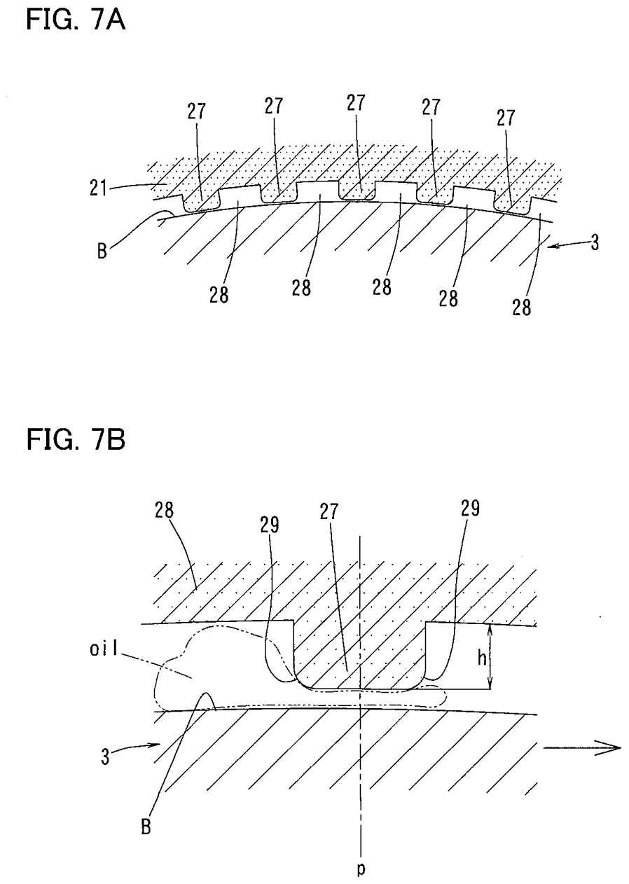

As shown in FIG. 7A, the seal lip 21 of each seal member 20 includes a plurality of circumferentially spaced apart protrusions 27. The protrusions 27 extend in a direction orthogonal to the circumferential direction along their entire length and are disposed at uniform intervals around the entire circumference. Accordingly, gaps 28 defined between respective circumferentially adjacent pairs of the protrusions 27 are also disposed at uniform intervals around the entire circumference. The gaps 28, which are defined between the seal lip 21 and the seal sliding surface B, constitute oil passages through which the bearing inner space A and the exterior of the bearing communicate with each other.

In addition, as shown in FIG. 7B, each protrusion 27 has circumferential ends 29 shaped such that the space between the protrusion 27 and the seal sliding surface B gradually increases/widens from the center of the circumferential width toward both circumferential sides. That is, a wedge-shaped gap is defined between the protrusion 27 and the seal sliding surface B so as to be larger on the sides closer to the adjacent gaps 28, and so as to be smaller near the circumferential width center p of the protrusion 27.

As shown in FIG. 6, each protrusion 27 has a region that generally extends along the seal sliding surface B on an imaginary plane including the bearing center axis. This region has a width in the direction along the seal sliding surface B (corresponding to the horizontal direction in FIG. 6, i.e., the axial direction). Accordingly, oil film formation is prompted by the wedge effect at the sliding portions between the protrusions 27 and the seal sliding surfaces B during bearing rotation, that is, where the protrusions 27 drag the lubricating oil within the gaps 28 circumferentially into the wedge-shaped gaps defined between the protrusions 27 and the seal sliding surfaces B. The area where an oil film is interposed between each protrusion 27 and the seal sliding surface B extends over a finite length not less than a predetermined value in the direction along the seal sliding surface B on the aforementioned imaginary plane (i.e., the axial direction). Since it is considered that such a sliding portion between each protrusion 27 and the seal sliding surface B occurs in an elliptical contact region based on Hertzian elastic contact theory, the major axis of the elliptical contact region corresponds to the aforementioned finite length.

When the circumferential speed of relative rotation between each seal lip 21 and the seal sliding surface B is less than a predetermined value, a boundary lubrication regime or a mixed lubrication regime occurs microscopically, in which solid contact regions tend to be present. If the circumferential speed of relative rotation between the protrusions 27 and the seal sliding surface B is not less than the predetermined value as the bearing rotation increases, the thickness of the oil film between the protrusions 27 and the seal sliding surface B significantly exceeds the composite roughness a between the protrusions 27 and the seal sliding surface B, thereby achieving a fluid lubrication regime in which the seal lip 21, more specifically, the respective protrusions 27 are completely separated from the seal sliding surface B by the oil film. When such a fluid lubrication regime is achieved, it is possible to reduce the seal torque generated by the seal member 20 to a level equivalent to that of a non-contact seal. As a result, it is possible to reduce a rise in the temperature of the sealed bearing, and to prevent adhesion of the seal lip 21.

If the oil film parameter Λ is greater than or equal to 3 (i.e., Λ≥3), it is considered that the lubrication mode of the sliding portion is the fluid lubrication regime. The oil film parameter Λ is defined as a ratio, at the sliding portion, of the minimum oil film thickness h₀ to the composite roughness σ, i.e., κ=h₀/(. The minimum oil film thickness h₀ is determined based on electrohydrodynamic lubrication theory. The composite roughness σ is expressed as: σ=√(Rq₁²+Rq₂²), wherein Rq₁ is a root mean square roughness of the seal sliding surface B forming the aforementioned sliding portion, and Rq₂ is a root mean square roughness of the surface of the protrusion 27, which is a value (μm) of a root mean square roughness Rq defined in JIS (B0601:2013).

The oil film parameter Λ depends on the composite roughness 6, and the smaller the composite roughness a is, the thicker the oil film can be made. In order to achieve a fluid lubrication regime at the sliding portions between the protrusions 27 and the seal sliding surface B, even if the aforementioned circumferential speed is very low, it is preferable that the composite roughness a at the sliding portions be set to 0.9 μm or less. When the oil lubrication mode based on the Johnson chart is determined under calculation conditions, for example, where the composite roughness a is 0.9 pam, the lubricating oil is a transmission oil (30 cst, 40° C.), the ambient temperature is 20° C., and the circumferential speed is 0.2 m/s, the minimum oil film thickness h₀ is 2.8 μm and the oil film parameter Λ is greater than or equal to 3. Therefore, the lubrication mode corresponds to the E-I mode. Accordingly, when the composite roughness σ of the protrusions 27 and the seal sliding surface B is 0.9 μm or less, a fluid lubrication regime can be reliably expected to be achieved within the actual operating range of the bearing.

For example, if the sealed bearing is used to support a rotary portion within a vehicle transmission, a transmission oil as lubricating oil is generally supplied to the sealed bearing by an appropriate method, such as splash lubrication or oil bath lubrication. The lubricating oil is circulated by an oil pump and filtered by an oil filter arranged in the circulation path. It is considered that if large-sized foreign matter having a particle size exceeding 0.05 mm enters the bearing inner space, this adversely affects the service life of the bearing. If the protrusion height h (see FIG. 7B) of each protrusion 27 is set to 0.07 mm or less, gaps 28 can be defined, through which such large-sized foreign matter cannot easily pass. In order to ensure good oil flow characteristics of the gaps 28, the protrusion height h of each protrusion 27 is desirably set to 0.05 mm or more.

If the protrusion height h of each protrusion 27 is 0.07 mm or less, for example, it is possible to set the interval between each circumferentially adjacent pair of protrusions 27 to 0.3 mm or more and 2.6 mm or less; set the circumferential width of each protrusion 27 to 0.2 mm or more and 1.0 mm or less; and set the radius of curvature of the surface of each protrusion 27 to 0.15 mm or more and less than 2.0 mm. In this example, if the oil temperature is 30 to 120° C. and the relative circumferential speed between the seal lip 21 and the seal sliding surface B is 0.2 m/s or more, it is considered that the lubrication mode, computationally, corresponds to either the rigid-isoviscous regime (R-I mode) or the elastic-isoviscous regime (E-I mode, soft EHL), that is, the aforementioned fluid lubrication regime, in the lubrication map (Johnson chart) based on the viscous parameter gv and the elastic parameter ge, which are non-dimensional values determined according to Greenwood-Johnson. If the interval between each circumferentially adjacent pair of protrusions 27 is 2.6 mm, an oil film of about 3 μm is, computationally, formed between the protrusions 27 and each seal sliding surface B. In contrast, if the interval is less than 2.6 mm, the oil film tends to be thicker. If the interval is 2.6 mm or less, the bearing rotational torque tends to decrease (i.e., the seal torque tends to decrease). If the interval is less than 0.3 mm, it is difficult to form a molded surface for molding the protrusions 27 in the mold using an end-milling process.

As described above, by achieving a fluid lubrication regime between each seal lip 21 and the seal sliding surface B, the friction caused by sliding between the seal lip 21 and the seal sliding surface B (i.e., the seal torque) can be reduced to substantially zero, thereby resulting in virtually no wear of the seal lip 21 and reducing heat generation due to sliding between the seal lip 21 and the seal sliding surface B. Further, since the allowable circumferential speed of relative rotation between the seal lip 21 and the seal sliding surface B increases, this allows for operation under higher-speed conditions than those of conventional designs.

As the material(s) for the seal lip 21, a single material or a plurality of materials selected from, for example, nitrile rubber, acrylic rubber, and fluororubber can be used. These materials may be used for the seal lip 21 alone or for the entire elastic portion 24, including the seal lip 21.

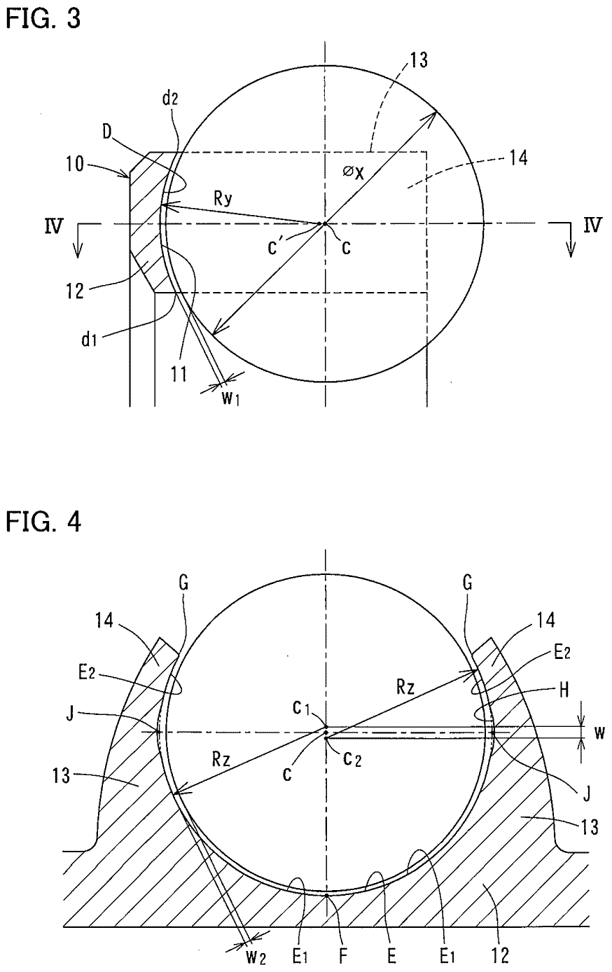

The pockets 11 of the cage 10 correspond to the balls 5, which have a diameter of φx. As shown in FIG. 3, the inner surface of each pocket 11 is an inner surface forming a circular are along the bearing radial direction (i.e., is a spherical surface), wherein its radius in the bearing radial direction is defined as Ry. 2Ry is twice Ry, which corresponds to the diameter of the inner surface of the pocket 11 in the bearing radial direction. That is, when the center of the pocket 11 is defined as the pocket center C, the inner peripheral surface D (hereinafter referred to as the “radially inner peripheral surface D”) of the pocket 11 on a cross section passing through the pocket center C and including the center axis O of the bearing (hereinafter referred to as the “radial cross section”) has a radius of Ry and a diameter of 2Ry (hereinafter referred to as the “radial pocket diameter 2Ry”). The bearing is designed such that the pocket center C coincides with the center of the ball 5. The center of the circular arc of the radially inner peripheral surface D is indicated by the reference numeral C′ in FIG. 3, and is offset toward the radially inner peripheral surface D relative to the pocket center C. As shown in FIG. 3, the radially inner peripheral surface D extends continuously from the radially outer end d2 to the radially inner end d1 in the bottom F of the pocket 11. While FIG. 3 shows a cross section passing through the bearing center line, this radial pocket diameter 2Ry is defined not only on this cross section, but also on any cross section including a bearing radial straight line connecting the pocket center C and the center axis O of the bearing (however, if a recess H such as an oil reservoir is formed in the inner surface of the pocket 11, the location of the recess H is not included).

In addition, as shown in FIG. 4, the inner surface of each pocket 11 is an inner surface forming a circular are along the bearing circumferential direction (i.e., is a spherical surface), wherein its radius of the bearing circumferential direction is defined as Rz. That is, the inner peripheral surface E (hereinafter referred to as the “circumferentially inner peripheral surface E”) of the pocket 11 on a cross section taken through the pocket center C in a direction orthogonal to the bearing radial straight line passing through the pocket center C (hereinafter referred to as the “circumferential cross section”) has a radius of Rz and a diameter of 2Rz (hereinafter referred to as the “circumferential pocket diameter 2Rz”). As shown in FIG. 4, the circumferentially inner peripheral surface E extends continuously from the distal end G of one of the opposed retaining claws 14, through the bottom F of the pocket 11, to the distal end G of the other retaining claw 14. While FIG. 4 shows a cross section passing through the pocket center C and orthogonal to the bearing radial straight line connecting the pocket center C and the center axis O of the bearing, this circumferential pocket diameter 2Rz is defined not only on this cross section, but also on any cross section taken through the pocket center C and intersecting with the bearing radial straight line passing through the pocket center C (however, if a recess H such as an oil reservoir is formed in the inner surface of the pocket 11, the location of the recess H is not included).

In FIGS. 3 and 4, the differences in diameters (radii) of the circular arcs and the positional relationship between the centers of the circular arcs are illustrated in an exaggerated manner.

The dimensional relationship among the diameter φx of the ball 5, the radial pocket diameter 2Ry and the circumferential pocket diameter 2Rz of the inner surface of the pocket 11 is set to satisfy φx<2Ry<2Rz.

In this regard, if the radial pocket diameter 2Ry (see FIG. 3) and the circumferential pocket diameter 2Rz of the pocket 11 were not greater than the diameter φx of the ball 5, the pocket 11 would tightly hold the ball 5, and thus the cage 10 would not function properly. Accordingly, it is required that φx<2Ry, and φx<2Rz.

Further, by setting the circumferential pocket diameter 2Rz (see FIG. 4) of the pocket 11 to be greater than the radial pocket diameter 2Ry (see FIG. 3) thereof, it is possible to easily avoid interference between the cage 10 and peripheral components (such as the inner ring 3 and the outer ring 4) caused by lagging or leading motion of the balls 5 during high-speed rotation, that is, interference involving deformation of the cage 10 caused by the balls 5 being pulled by the cage 10 due to circumferential speed differences while the balls 5 rotate in the bearing circumferential direction. This effect is obtained by satisfying 2Ry<2Rz such that the second gap w2 (see FIG. 4) between the ball 5 and the circumferentially inner peripheral surface E of the pocket 11 is larger than the first gap w1 (see FIG. 3) between the ball 5 and the radially inner peripheral surface D of the pocket 11.

In the cross section of FIG. 3, the radially inner peripheral surface D forms a circular arc with the diameter 2Ry, with reference numeral d1 indicating its radially inner end d1 and reference numeral d2 indicating its radially outer end d2. In addition, in the cross section of FIG. 4, the circumferentially inner peripheral surface E forms a circular arc with the diameter 2Rz, with reference numeral F indicating its bottom F. Further, reference numeral G indicates the distal end G of the retaining claw 14.

On the other hand, if the 2Ry dimension of the pocket 11 is too large, the radial play between the balls 5 and the cage 10 will increase, thus making interference between the cage 10 and peripheral components (such as the inner ring 3 and the outer ring 4) more likely to occur. In addition, during high-speed rotation, in combination with the influence of centrifugal deformation, the above interference is even more likely to occur. Accordingly, the 2Ry dimension should not be too large. As a result, the inventors of the present application have confirmed that the condition 2Ry<2Rz is preferable. However, in order to reduce such interference, it is required that the cage 10 be formed of an engineering plastic.

In addition, as shown in FIG. 4, the circumferentially inner peripheral surface E has a first inner peripheral surface portion E₁ on the side of the base 12, and a second inner peripheral surface portion E₂ extending toward the retaining claws 14, that is, toward the distal ends of the pillars 13 beyond the first inner peripheral surface portion E₁, wherein the center C₂ of the circular arc of the second inner peripheral surface portion E₂ is offset toward the base 12 relative to the center C₁ of the circular arc of the first inner peripheral surface portion E₁. Accordingly, it is possible to ensure a large second gap w2 between the ball 5 and the circumferentially inner peripheral surface E of the pocket 11 while maintaining the retaining function of the balls 5.

In FIG. 4, the line connecting the center C₁ of the circular arc of the first inner peripheral surface portion E₁ of the circumferentially inner peripheral surface E and the center C₂ of the circular arc of the second inner peripheral surface portion E₂ thereof is parallel to the bearing axial direction. In addition, the pocket center C is desirably located at the midpoint between the center C₁ of the circular arc of the first inner peripheral surface portion E₁ and the center C₂ of the circular arc of the second inner peripheral surface portion E₂. Further, while the distance w between the center C₁ of the circular are of the first inner peripheral surface portion E₁ and the center C₂ of the circular arc of the second inner peripheral surface portion E₂ is appropriately set according to the diameter φx of the ball 5, the specifications of the bearing, and the like, the distance w can be set to a value between 0.1 and 0.2 mm.

If the circumferential pocket diameter 2Rz is too large, the axial play of the cage 10 will increase as a disadvantage. If the axial play of the cage 10 is large, interference between the cage 10 and the seal member 20 may occur depending on the operating conditions. For this reason, in consideration of the above axial play and the deformation of the cage 10 due to a centrifugal force, it is desirable to ensure an axial clearance of 0.1 mm or more between the seal member 20 and the cage 10.

According to the above arrangement, the bearing 1 is applicable under high-speed conditions in which a dmn value reaches 700,000 or more at the maximum rotational speed, the dmn value being defined by:

dms={(D+d)/2}×n,
D: Bearing outer diameter (mm),
d: Bearing inner diameter (mm), and
n: Rotational speed (min⁻¹).

Along with this, the entry of foreign matter of a size that adversely affects the service life of the bearing can be also reduced. Further, deformation of the cage 10 during high-speed operation can be reduced, and jamming of foreign matter between the cage 10 and the seal member 20 can be also prevented.

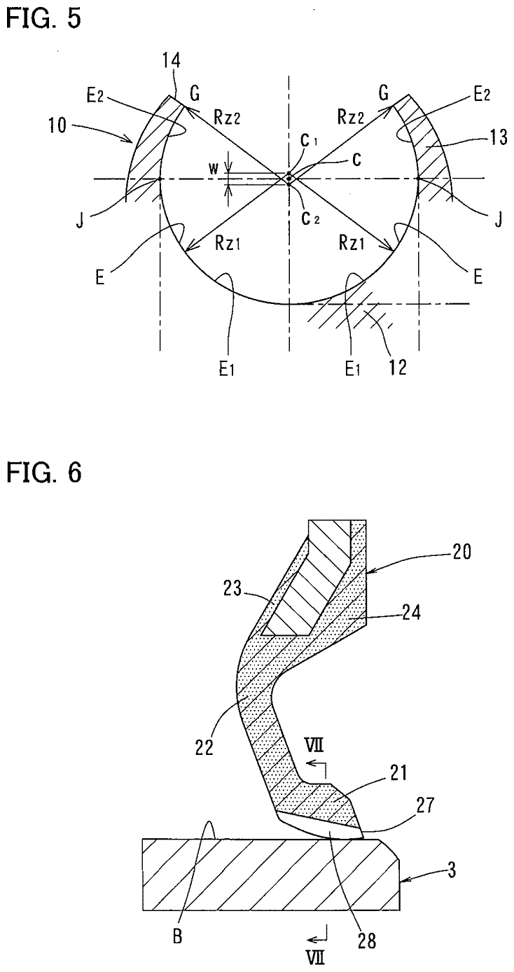

With respect to the above radius Rz of the circumferentially inner peripheral surface E, the radius Rz₁ of the first inner peripheral surface portion E₁ and the radius Rz₂ of the second inner peripheral surface portion E₂ are desirably set to the same numerical value. However, provided that the retaining function of the balls 5 is maintained and the second gap w2 is ensured, for example, as shown in FIG. 5, the radius Rz₁ of the first inner peripheral surface portion E₁ and the radius Rz₂ of the second inner peripheral surface portions E₂ may be different numerical values. In this case, the radius Rz₁ of the first inner peripheral surface portion E₁ may be set to be a numerical value larger or smaller than the radius Rz₂ of the second inner peripheral surface portion E₂.

In FIG. 5, the recess H for an oil reservoir in the inner surface of the pocket 11 is omitted. The theoretical connecting point between the first inner peripheral surface portion E₁ and the second inner peripheral surface portion E₂ lies on a plane that passes through the pocket center C and is orthogonal to the axial direction of the bearing. This theoretical intersection point is indicated by reference numeral J in FIG. 5. When the theoretical intersection point J is viewed macroscopically, a bending point is interposed between the first inner peripheral surface portion E₁ and the second inner peripheral surface portion E₂ due to their direct connection. For this reason, it is preferable that, near the theoretical intersection point J, both of the inner peripheral surface portions be smoothly connected to each other so that their curvatures continue as much as possible and no bending point or the like with discontinuous curvature is interposed. In this case, for example, if, as shown in FIG. 4, the recess H as an oil reservoir is provided between the first inner peripheral surface portion E₁ and the second inner peripheral surface portion E₂, the theoretical intersection point J lies within the recess H, thereby eliminating the problem of a bending point between the first inner peripheral surface portion E₁ and the second inner peripheral surface portion E₂.

In the above embodiment, since a lubricant (lubricating oil) is supplied to the bearing inner space A from both axial sides, i.e., the one axial end and the other axial end, the present invention has been described with reference to an example of a double-side sealing arrangement in which the seal members 20 are provided in the respective openings at the one axial end and the other axial end. As another example, if a lubricant (lubricating oil) is supplied to the bearing inner space A in a single direction from the one axial end toward the other axial end, a single-side sealing arrangement may be used in which the seal member 20 is disposed only in the one axial end opening. That is, in the case of the single-side sealing arrangement, the seal member 20 is desirably disposed in the opening through which a lubricant (lubricating oil) is supplied. In addition, in the single-side sealing arrangement, the cage 10 is desirably inserted into the bearing inner space A from the non-sealed side, on which the seal member 20 is not disposed.

As mentioned above, in the bearing 1, which is used under high-speed conditions where the dmn value at the maximum rotational speed reaches 700,000 or more, it is required to reduce the deformation of the cage 10 during high-speed rotation by applying a crown-shaped cage formed of an engineering plastic. However, when applying this crown-shaped resin cage, for example, if the amount of the lubricant (lubricating oil) entering the bearing inner space A is large, the service life of the bearing may be reduced. In addition, depending on operating conditions of the bearing 1, there is a concern that foreign matter such as gear wear dust may enter the bearing inner space A, thereby reducing the service life of the bearing. For this reason, in the present invention, by using seal members 20 capable of maintaining the contact portions of the seal lips 21 in the fluid lubrication regime, it is possible to reduce the entry of foreign matter that adversely affects the service life of the bearing and to control the amount of the lubricant (lubricating oil) entering the bearing inner space. That is, due to the synergistic effect of a crown-shaped resin cage having a predetermined shape and performance and seal members 20 capable of maintaining the contact portions of the seal lips 21, it is possible to extend the service life of the bearing compared to conventional bearings.

Table 1 below shows the results of rapid acceleration and deceleration tests conducted under different inner oil amounts of the crown-shaped resin cage.

TABLE 1

| | | Operation Period | |
|---|---|---|---|
| Oil Supply Point | Test | (Time until cage | |
| (Oil Amount) | No. | failure/No seal) | Ratio |
| Center Axis | 1 | 20.9 h | 1 |
| (Oil: More) | 2 | 20.9 h | 1 |
| Lowest Element | 3 | 57.5 h | 2.8 |
| (Oil: Less) | 4 | 57.5 h | 2.8 |

Part Number 5A-2TA-6207HSGT2CM45
Rotational Speed 0~20000(min−1)
Radial Load 1500N
Lubrication CVT Fluid 70° C.

The above results show that when the amount of the lubricant (lubricating oil) entering the bearing inner space A is small, the service life of the bearing is extended. This is considered to be because the stirring resistance decreases when the amount of the lubricant (lubricating oil) entering the bearing inner space is small. As described above, the seal members 20, which are capable of maintaining the contact portions of the seal lips 21 in the fluid lubrication regime, can, for example, prevent the entry of foreign matter of 0.050 mm or more, which adversely affects the fluid lubrication and the service life of the bearing. In addition, while the seal members 20 are contact seals, the fluid lubrication regime is achieved during operation. Therefore, it is not necessary to ensure more than the required amount of the lubricant (lubricating oil) entering the bearing inner space. As shown in Test Nos. 3 and 4 of Table 1 above, no problem occurs even if excessive lubricant (lubricating oil) entry into the bearing inner space A is avoided.

While the cage 10 is formed of an engineering plastic in the above embodiment, the cage 10 may be formed of a material containing at least an engineering plastic.

In the above embodiment, examples of the rotary shaft include a rotary shaft of a drive motor of electric transportation equipment, such as electric vehicles, and a rotary shaft of a speed reducer or a speed increaser of the electric transportation equipment. Alternatively, in addition to these, the bearing 1 of the present invention, as well as a bearing device comprising the bearing 1, is also applicable to supporting portions of rotary shafts in various transportation equipment, industrial machinery, and the like. For example, the bearing and the bearing device are applicable to shafts in power transmission paths of various transportation equipment, constant velocity joints, propeller shafts, rotating portions of forced induction devices, transmissions, and wheel bearings, as well as to supporting portions of rotary shafts in various machine tools, power generators, and similar equipment.

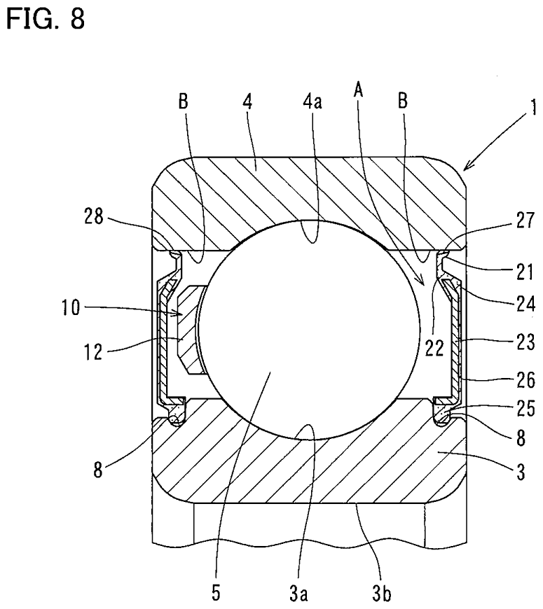

In addition, in the above embodiment, the arrangement of the present invention has been described with reference to an example of the sealed ball bearing 1 in which the seal lips 21 of the seal members 20 are arranged on the inner ring 3. Alternatively, this arrangement may be reversed; for example, as shown in FIG. 8, an arrangement may be used in which the seal lips 21 are arranged on the outer ring 4.

Further, in the above embodiment, an arrangement is used in which the elastic portion 24 of each seal member 20 is formed of rubber, and the rubber is boned by vulcanization to the metal core 23. Alternatively, the rubber may be integrally bonded to the metal core 23 by a bonding method other than vulcanization bonding. Furthermore, provided that the strength and resistance of the seal members 20 are ensured, seal members 20 each consisting of only the elastic portion 24 without including the metal core 23 may be used. Moreover, as the material for each elastic portion 24, a material other than rubber, such as synthetic resins, may be used.

The above-described embodiments are mere examples in every respect, and the present invention is not limited thereto. The scope of the present invention is indicated by not the above description but the claims, and should be understood to include all modifications within the meaning and scope equivalent to the scope of the claims.

### DESCRIPTION OF REFERENCE NUMERALS

1: Bearing (sealed ball bearing)
3: Inner ring
4: Outer ring
5: Ball (rolling element)
10: Cage
11: Pocket
12: Base
13: Pillar
20: Seal member
21: Seal lip
27: Protrusion
28: Gap
A: Bearing inner space
B: Seal sliding surface
C: Pocket center
D: Radially inner peripheral surface
E: Circumferentially inner peripheral surface
E₁: First inner peripheral surface portion
E₂: Second inner peripheral surface portion

1. A sealed ball bearing comprising:
an inner ring and an outer ring between which a bearing inner space is defined;
balls disposed between the inner ring and the outer ring;
a cage having pockets circumferentially retaining the respective balls; and
a seal member closing an axial end opening of the bearing inner space,
wherein the sealed ball bearing is used in an environment of a dmn value of 700,000 or more, the dmn value being defined by:
$$dms = \{ ( D + d ) / 2 \} \times n ,$$
D: Bearing outer diameter,
d: Bearing inner diameter, and
n: Rotational speed,
wherein the seal member comprises a seal lip that is fixed to one of the inner ring and the outer ring, and that is in sliding contact with a seal sliding surface of the other of the inner ring and the outer ring,
wherein the seal lip includes a plurality of protrusions circumferentially spaced apart from each other such that gaps are defined between respective circumferentially adjacent pairs of the protrusions, and such that, during rotation of the bearing, a lubricating oil is dragged from the gaps to between the protrusions and the seal sliding surface so as to form an oil film therebetween, thereby achieving a fluid lubrication regime between the seal lip and the seal sliding surface,
wherein the cage is a crown-shaped cage containing an engineering plastic, and comprising an annular base; and a plurality of pillars protruding unidirectionally from the base,
wherein a dimensional relationship among φx, Ry, and Rz satisfies φx<2Ry<2Rz, wherein φx is a diameter of each of the balls, Ry is a radius of a radially inner peripheral surface of each of the pockets on a cross section passing through a pocket center of the pocket and including a center axis of the bearing, and Rz is a radius of a circumferentially inner peripheral surface of each of the pockets on a cross section taken through the pocket center in a direction orthogonal to a bearing radial straight line passing through the pocket center, and
wherein the circumferential inner peripheral surface of each of the pockets has a first inner peripheral surface portion on a side of the base; and a second inner peripheral surface portion extending toward distal ends of corresponding ones of the pillars beyond the first inner peripheral surface portion, and a center of the second inner peripheral surface portion is offset toward the base relative to a center of the first inner peripheral surface portion.

2. The sealed ball bearing according to claim 1, wherein the radius Rz of the circumferentially inner peripheral surface of each of the pockets is set such that a radius Rz₁ of the first inner peripheral surface portion is equal to a radius Rz₂ of the second inner peripheral surface portion.

3. The sealed ball bearing according to claim 1, wherein a recess as an oil reservoir, is disposed between the first inner peripheral surface portion and the second inner peripheral surface portion in each of the pockets.

4. The sealed ball bearing according to claim 1, wherein the seal lip is formed of a single material or a plurality of materials selected from nitrile rubber, acrylic rubber, and fluororubber.

5. The sealed ball bearing according to claim 1, wherein a lubricant is to be supplied to the bearing inner space in a single direction from a first axial end of the bearing inner space toward a second axial end of the bearing inner space, and the seal member is disposed only in an opening of the bearing inner space at the first axial end.

6. A bearing device wherein the sealed ball bearing according to claim 1 is used, and wherein a rotary shaft of a drive motor, a speed reducer, or a speed increaser for electric transportation equipment is supported by the sealed ball bearing.

7. The sealed ball bearing according to claim 2, wherein a recess as an oil reservoir, is disposed between the first inner peripheral surface portion and the second inner peripheral surface portion in each of the pockets.

8. The sealed ball bearing according to claim 2, wherein the seal lip is formed of a single material or a plurality of materials selected from nitrile rubber, acrylic rubber, and fluororubber.

9. The sealed ball bearing according to claim 3, wherein the seal lip is formed of a single material or a plurality of materials selected from nitrile rubber, acrylic rubber, and fluororubber.

10. The sealed ball bearing according to claim 2, wherein a lubricant is to be supplied to the bearing inner space in a single direction from a first axial end of the bearing inner space toward a second axial end of the bearing inner space, and the seal member is disposed only in an opening of the bearing inner space at the first axial end.

11. The sealed ball bearing according to claim 3, wherein a lubricant is to be supplied to the bearing inner space in a single direction from a first axial end of the bearing inner space toward a second axial end of the bearing inner space, and the seal member is disposed only in an opening of the bearing inner space at the first axial end.

12. The sealed ball bearing according to claim 4, wherein a lubricant is to be supplied to the bearing inner space in a single direction from a first axial end of the bearing inner space toward a second axial end of the bearing inner space, and the seal member is disposed only in an opening of the bearing inner space at the first axial end.

13. A bearing device wherein the sealed ball bearing according to claim 2 is used, and wherein a rotary shaft of a drive motor, a speed reducer, or a speed increaser for electric transportation equipment is supported by the sealed ball bearing.

14. A bearing device wherein the sealed ball bearing according to claim 3 is used, and wherein a rotary shaft of a drive motor, a speed reducer, or a speed increaser for electric transportation equipment is supported by the sealed ball bearing.

15. A bearing device wherein the sealed ball bearing according to claim 4 is used, and wherein a rotary shaft of a drive motor, a speed reducer, or a speed increaser for electric transportation equipment is supported by the sealed ball bearing.

16. A bearing device wherein the sealed ball bearing according to claim 5 is used, and wherein a rotary shaft of a drive motor, a speed reducer, or a speed increaser for electric transportation equipment is supported by the sealed ball bearing.
